(19) United States
(12) Patent Application Publication
(10) Pub. No.: US 2009/0174294 A1
(43) Pub. Date: Jul. 9, 2009

(54) DEFLECTOR FOR AN ELECTROMAGNETIC RETARDER AND ELECTROMAGNETIC RETARDER INCLUDING ONE SUCH DEFLECTOR

(76) Inventors: Bruno Dessirier, Saint Germain en Laye (FR); Hailly Stephane, Issy Les Moulineaux (FR); Claudiu Vasilescu, Paris (FR)

Correspondence Address: BERENATO, WHITE & STAVISH, LLC, 6550 ROCK SPRING DRIVE, SUITE 240, BETHESDA, MD, 20817, US

(21) Appl. No.: 12/090,436

(22) PCT Filed: Dec. 5, 2006
(86) PCT No.: PCT/FR2006/002657

§ 371 Date: Dec. 18, 2008

(30) Foreign Application Priority Data
Dec. 5, 2005 (FR) 0553726

(51) Int. Cl. H02K 5/20; H02K 7/104

(52) U.S. Cl. 310/60 A; 310/93

(57) ABSTRACT

A deflector for an electromagnetic retarder including a rotary shaft with a fan for circulating a cooling gas to the induction coils which are intended, upon command, to generate Foucault currents in a stator surrounding the rotary shaft and the induction coils. The inventive deflector (1) includes a body (2) which is provided with at least one return face (3), known as the radial return face, which is intended to release the gas radially from the retarder, said body (2) being shaped such that the deflector (1) can be disposed non-rotatably and coaxially in relation to the shaft of the retarder.

### FIELD OF THE INVENTION

The present invention concerns a deflector intended to be arranged coaxially with respect to a rotating shaft of an electromagnetic retarder, and an electromagnetic retarder comprising such a deflector.

### PRIOR ART

An electromagnetic retarder comprises means for creating a stream of a gaseous fluid, typically a stream of air, for cooling the induction coils disposed in a ring on a rotor of the retarder and inside a stator that surrounds the rotor and is intended to be mounted on a chassis of a vehicle. One of these means is a fan described for example in the documents EP-A-0331559 and FR-A-1467310.

In electromagnetic retarders the fan also often serves to cool other heating elements, for example electronic circuits. Some retarders comprise two fans; they are generally attached to a shaft of the retarder. Thus, when a retarder starts to operate, the fan or fans create a stream of air that flows towards the coils of the retarder and towards the electronic circuits in order to cool them. This cooling prevents a drop in performance of the hot retarder. Overall, by virtue of the increase in performance, a fan contributes to creating up to ten percent of the total retarding torque generated by the retarder.

However, the use of such fans has limits.

This is because, as the shaft of the retarder rotor is often connected to the output shaft of the gearbox or a speed-multiplier transmission box, the shaft of the rotor is turning continuously. The driving of the fan therefore gives rise to a not insignificant consumption of mechanical power, even when the retarder is not in operation. In other words, even when the retarder is not activated, the fan consumes an unnecessary mechanical torque, which results in an unnecessary consumption of fuel, generally diesel. This is also valid when the retarder is connected to the input shaft of the rear axle of a motor vehicle.

In summary, as soon as, or for as long as, the rotor of the electromagnetic retarder is turning, ventilation losses can be observed even when the retarder is not activated. These losses, which are also called off-load losses and which are due to the driving of the fan, make the speed output of the vehicle drop fairly substantially, since they increase with the power of three of the speed of rotation of the rotor shaft. Moreover, the fans make a noise.

For these reasons, the manufacturers of so-called heavy vehicles such as lorries, coaches and buses and special vehicles such as refuse-collection vehicles, are more and more often indicating in a specification a maximum of off-load losses to be observed when the retarder is not functioning. These losses must be very much less than the losses caused by the fan when the retarder is functioning. In addition, the noise of the fan in phases of non-use of the retarder should not exceed a predetermined level.

To mitigate the various drawbacks stated above, some retarders have been equipped with disengageable fans. Thus tests have been carried out with electromagnetic clutches with coils or of the powder type. Other tests have been carried out with fans with viscostatic disengagement or hydraulic control. However, in all cases, it was a question of axial fans and the solutions proposed were not transposable to radial fans, since the means proposed comprised elements disposed parallel to the axis of the retarder. Some of these elements would then at least partially block the flow of the centrifugal fan by forming a screen perpendicular to the flow of air.

However, in electromagnetic retarders comprising a fan at the entry to the space to be cooled and another fan at the outlet, the fan disposed at the outlet must be a radial fan because of the presence of the mechanical unit (rear axle, gearbox or the like) to which the output shaft of the retarder is connected. Since the use of an axial fan at this point would cause very large pressure drops greatly reducing the flow of air passing inside the retarder.

### OBJECT OF THE INVENTION

The aim of the invention is to mitigate the various drawbacks stated above.

More particularly, the invention must propose a solution that if possible makes it possible to have a robust, simple and compact system that, when the solution was to comprise additional parts compared with the fans used before the invention, makes it possible to house them inside the retarder or, at least, so that they do not contribute to an increase in the overall size of the retarder.

At the least, the invention must propose a solution for improving the performance of the retarder, in particular by reducing off-load losses. In other words, the invention must facilitate the cooling of the coils, whilst limiting the consumption of a torque on the shaft, in particular during periods of non-use of the retarder.

The aim of the invention is achieved with a deflector for an electromagnetic retarder comprising a rotating shaft with a fan for causing a cooling gaseous fluid to flow over induction coils intended to generate, on command, eddy currents in a stator surrounding the rotating shaft and the induction coils.

In accordance with the invention, the deflector comprises a body provided with at least one return face, referred to as a radial return face, intended to make the retarder gaseous fluid discharge radially, the body being conformed so as to make it possible to arrange the deflector non-rotationally and coaxially with respect to the shaft of the retarder.

To mitigate the drawbacks indicated above of the retarders used before the invention, the invention therefore proposes to use a stationary mechanical interface and to arrange it in the rear part of the retarder, seen in the direction of flow of the cooling gaseous fluid, that is to say approximately at the point where a radial fan is disposed in the retarders used before the invention.

The arrangement of immobile radial return means at the rear of an electromagnetic retarder cleverly uses the design of the retarder. The retarder comprises a rotating shaft intended to be attached to a main or secondary output shaft of a gearbox, to an input shaft of a rear axle of a motor vehicle, to a rear axle of a trailer or semi-trailer or to a speed-multiplication transmission box, as well as a rotor rotationally secured to the rotating shaft, induction coils disposed in a ring on the rotor and inside a stator surrounding the rotor and intending to be mounted on a chassis of the vehicle, a generator mounted on one end of the rotating shaft of the rotor and supplying the induction coils, and an axial-action fan for causing a cooling gaseous fluid to enter inside the retarder and to cause it to flow over the induction coils. The discharge of the gaseous fluid is assisted by means giving to the flow of gaseous fluid a transverse orientation with respect to the axis of the retarder.

Instead of using, as before the invention, a radial fan, the invention therefore uses means that are permanently immobile, which do not require any control means and whose shape can be optimised so as to reduce the noise generated by the friction and turbulence of the cooling gaseous fluid along the walls.

The invention thus makes it possible to increase the performance of the retarder through better mastery of the cooling of the coils but also through good mastery of the fuel consumption of the vehicle outside the use of the retarder, that is to say 85% of its time approximately.

The solution that the invention proposes is simple to integrate in the design of a retarder, is not bulky, and is lightweight and very economical.

The invention also concerns the following characteristics considered in isolation or according to any technically possible combination:
the body of the deflector is an individual piece;
the body of the deflector is formed by a rear plate of the retarder;
the body of the deflector is formed from flat plates;
the body of the deflector has a frustoconical shape overall;
the deflector comprises two radial return faces each disposed over approximately half of the body of the deflector;
the deflector comprises three radial return faces, one of which is disposed over approximately a first half of the body of the deflector and the other two of which are disposed together over approximately a second half of the body of the deflector;
the radial return faces each have approximately the shape of a channel in an arc of a circle;
the radial return faces each have approximately the shape of a channel in a helical arch;
the radial return faces are formed by attached elements or formed in a single piece with the body of the deflector and having the general form of blades of a centrifugal or helico-centrifugal fan.

The aim of the invention is also achieved with an electromagnetic retarder comprising a deflector having the characteristics described above.

### BRIEF DESCRIPTION OF THE DRAWINGS

Other characteristics and advantages of the present invention will emerge from the following description of an embodiment of the invention, this description being given with reference to the accompanying drawings, in which:

FIG. 1 is a perspective view, with local cutaway, of an electromagnetic retarder comprising several fans mounted on a rotating shaft of the retarder secured to an output shaft of a gearbox;

FIG. 2 shows a deflector according to one embodiment of the invention in a perspective view,

FIG. 3 shows a deflector according to a variant embodiment of the invention in a front view,

FIG. 4 shows the deflector of FIG. 3 in a view in section along a cutting line IV-IV in FIG. 3,

FIG. 5 shows the deflector of FIG. 3 in a perspective view with a cutaway, and

FIG. 6 shows the arrangement of a deflector of the invention with respect to the coils of a retarder rotor.

These figures are given by way of illustration and are not limitative of the invention.

In these figures, the identical or similar elements will be allocated the same reference numbers.

### DESCRIPTION OF A FIRST EMBODIMENT OF THE ARRANGEMENT ACCORDING TO THE INVENTION

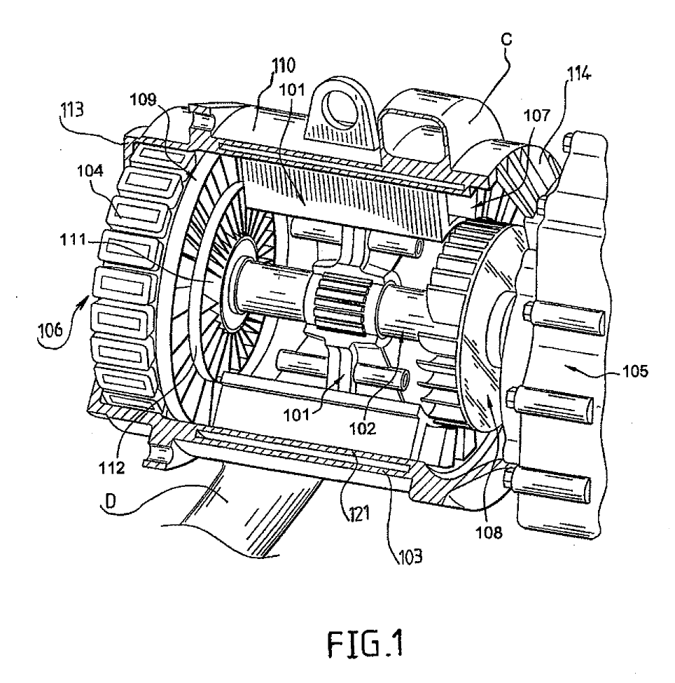

FIG. 1 sets out the general structure of an electromagnetic retarder with two fans mounted on a rotating shaft of the retarder.

The electromagnetic retarder is depicted in a perspective view with partial axial cutaway and as being mounted on a gearbox 105 of a motor vehicle. This retarder is intended to retard a transmission shaft of the vehicle and more particularly here the output shaft of the gearbox 105, here via a speed multiplier described for example in the document FR-A-2861912, to which reference should be made, by generating a magnetic field with alternating distribution in a ferromagnetic piece 121 of a stator 110, which also comprises a cooling jacket 103 in a helical shape in a single turn. The jacket 103 is provided with an inlet conduit C and a discharge conduit D. The jacket 103 delimits, with the internal piece 121, a chamber inside which a cooling fluid circulates, here that of the thermal engine of the vehicle.

The retarder comprises a rotating shaft 102 attached to the output shaft of the gearbox 105 and a rotor 101 rotationally secured to the rotating shaft 102. Induction coils 107 are disposed in a ring on the rotor 101 and inside the stator 110 surrounding the rotor 101. The stator 110, which comprises the cooling water jacket 103 and the internal piece 121, is intended to be mounted on a chassis of the vehicle. The retarder also comprises a generator 106 mounted on one end of the rotating shaft 102 of the rotor 101, a rotor (not visible) constituting an armature of the generator 106 and two fans 108 and 109 for causing a cooling gaseous fluid, generally air, to flow over the induction coils 107, and therefore for cooling the rotor 101. The fan 109 is axially acting whereas the fan 108 is radially acting, that is to say of the centrifugal type, the blades of these two fans being configured accordingly.

The generator 106 supplies the excitation energy necessary for generating the alternating-distribution magnetic field. This generator 106 comprises an inducing stator formed by a ring of coils or windings 104 of electric wires around cores constituting multiple magnetic poles with alternating polarities, and the rotor. The inducing stator surrounds the armature rotor with a small air gap. A bridge rectifier (not visible) is interposed between the armature rotor of the generator 106 and the coils, as described in the documents EP-A-0331559 and FR-A-1467310.

The coils 104 are supplied by a DC source such as a battery of the vehicle equipped with the retarder. The intensity of this current is adjusted according to the retarding torque that the retarder must produce. This is because, by regulating the intensity of the induction current of the coils 104, the intensity of the electric current generated by the generator 106 is adjusted and, by this finally, the intensity of the eddy currents generating retarding and heating torque, generated in the ferromagnetic piece 121 of the stator 110 of the retarder.

The generation of the electrical supply current necessary for the generation of the eddy currents, by a generator 106 integrated in the retarder, affords a dual advantage. The first advantage consists of a very low supply of external electrical energy taken from the vehicle battery, for example around 20% to 30% of the total energy necessary. The second advantage is that the generation of the electric current by the generator itself consumes a certain amount of mechanical energy taken from the shaft to be retarded.

The excitation current generated by the generator 106 supplies the induction coils 107 of the rotor 101 of the retarder in order to generate a magnetic field. The coils 107 are formed by windings of electric wires around cores forming integral parts of the rotor 101. The cores belong to the body of the rotor 101 made from ferromagnetic material and form projecting poles. The magnetic field induces the stator 110 of the retarder and generates eddy currents therein, in particular in the internal piece 121 of the stator 110 produced from a ferromagnetic material. The eddy currents being opposed, by their effects, to the cause that gives them the direction, namely the rotation movement of the rotor, the rotation movement of the rotor 101 thus generates a reverse rotation torque retarding the shaft 102.

The generation of the eddy currents being accompanied by heating, by Joule effect, in particular of the internal piece 121 of the stator 110, this piece is cooled by the fluid circulating in the cooling jacket 103. At the same time, there is the creation of a stream of air, inside the retarder, under the action of the fans 108 and 109. The air enters the retarder axially through a perforated cover 113 under the action of the fan 109 and then flows inside the retarder, in particular cooling the coils 107, in order finally to be driven out radially by the rear fan 108, of the centrifugal type, through a perforated support 114.

This arrangement gives satisfaction. Nevertheless it was desired, in particular for economic reasons, to be able to omit the rear fan.

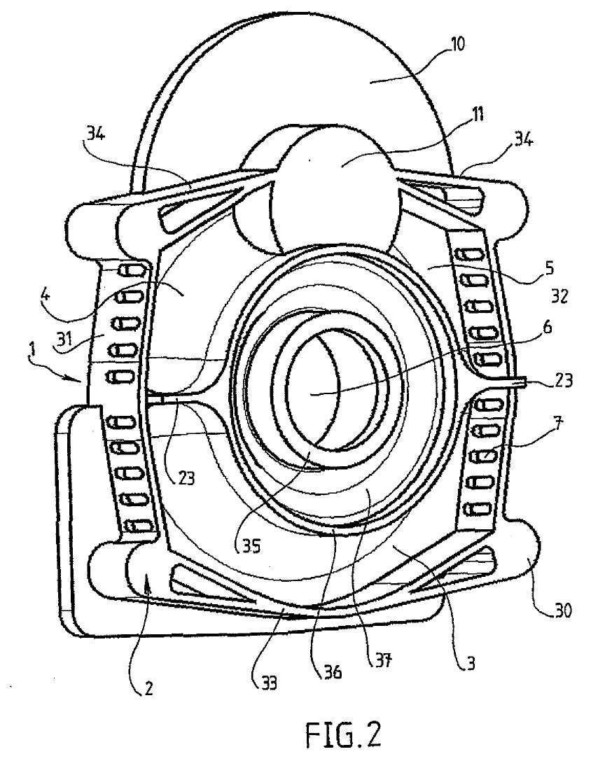

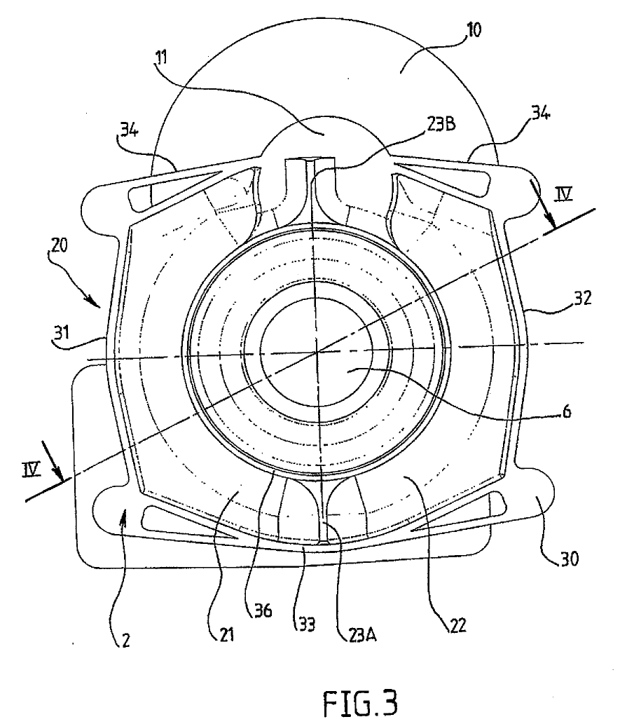

According to the proposal of the invention, the rear fan is replaced by a deflector 1 (FIG. 2) or 20 (FIG. 3 et seq) and the perforated rear support 114 is conformed accordingly.

The rear support 114 of FIG. 1 is thus replaced by an exit piece. This exit piece is produced from castable material, for example based on aluminium like the cooling jacket 103. This piece is conformed at the same time in order to constitute an exit plate.

FIG. 2 shows a deflector 1 according to one embodiment of the invention in a perspective view. The deflector 1 is integrated in an exit plate 10 of an electromagnetic retarder, that is to say formed in a single piece with it, and comprises a body 2 provided with three return faces 3 to 5, referred to as radial return faces, disposed around an opening 6. The opening 6 is central, while the radial return faces 3 to 5 are intended to discharge the gaseous fluid radially from the retarder, for example through radial outlet apertures 7 provided in the body 2. By virtue of the opening 6 the body 2 can be disposed coaxially with respect to the shaft 102 of the retarder. In addition, the opening 6 is conformed so as to cooperate with, or form part of, a bearing for the shaft 102 that thus passes through the deflector without making it rotationally integral with the shaft 102. By virtue of this arrangement of the invention, the deflector can be mounted so as to be immobile with respect to the exit plate or, as in the embodiment depicted, be an integral part of the exit plate.

The deflector depicted in FIG. 2 comprises three return faces referenced respectively 3, 4 and 5. Each of these return faces is conformed so as to reorient a corresponding part of the flow of cooling gaseous fluid passing axially through the inside of the retarder, in order to give it a radial orientation towards radial exit openings of the plate, for example the outlet apertures 7. Whereas the return face 3 occupies approximately half of the space around the opening 6, the two return faces 4, 5 each occupy approximately a quarter of this space. This is due to the presence of a protrusion 11 in the plate 10, oriented towards the inside of the retarder.

Each of the return faces 3, 4 and 5 has the general form of a channel formed in a helical arch. However, alternatively, these faces could each have the form of a toroidal arch. The essential thing is to conform the return faces 3, 4 and 5 so that they can reorient the flow of gaseous fluid relatively gently, that is to say not abruptly, in order to avoid mechanical losses as far as possible.

The assembly consisting of body 2 and exit plate 10 is obtained here by casting material based on aluminium and at 30 four lugs can be seen. These lugs 30 are intended to be pierced to form passage holes for fixing members, such as screws, for fixing the cooling jacket 103 on this assembly. The assembly also comprises other holes (not visible in the drawings) for affixing it to the casing of the gearbox 105. Naturally the number of lugs 30 depends on the application.

The outlet apertures 7 are formed in two axially oriented lateral rims 31, 32, each rim 31, 32 connecting together two lugs 30. Top 34 and bottom 33 partitions are also provided, lightened by recesses.

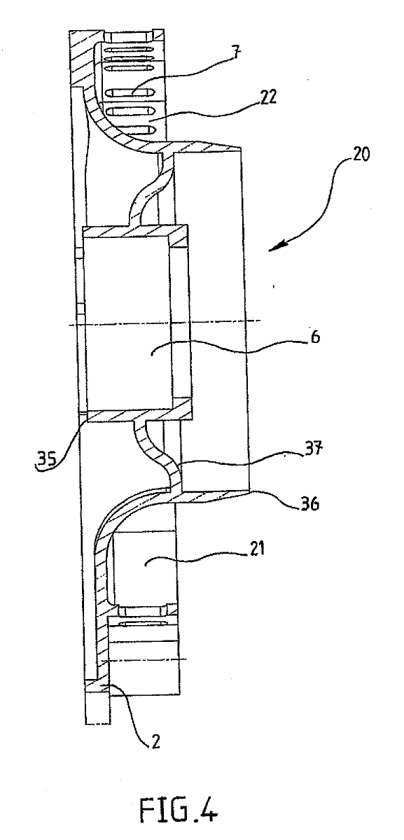

The top partition 34 is in two parts, the protrusion 11 being interposed between the two parts. The protrusion 11 is due here to the presence of a speed multiplier interposed between the shaft 102 and a secondary output shaft of the gearbox 105. More precisely, this speed multiplier comprises gears, a first of which is mounted in the protrusion 11. Another gear is provided. This gear meshes with the first gear and comes into engagement with the fluted end of the shaft 102, which passes through the opening 6 delimited by a first sleeve or internal sleeve 35. This sleeve 35 is connected by a tortuously shaped web 37 to a second sleeve or external sleeve 36 axially extending the return faces 3 to 5. The web 37 and the sleeves 35, 36 are also visible in FIGS. 4 to 6.

Junctions 23 each connect one of the rims 31, 32 to the external sleeve 36. The junctions 23 are separation partitions between the return face 3 and respectively the return face 4 and the return face 5, the return faces 4 and 5 being separated from each other by the protrusion 11. Thus blind cavities are formed, delimited by the return faces 3 to 5, the external sleeve 36, the rims 31, 32, the partitions 34, 33 and the junctions 23, as can be seen in FIG. 2.

The return faces 3 to 5 are in general curved so as to return the air towards the apertures 7. The number of return faces depends on the application. Thus, in other examples, this number of faces is different from three, for example four or two. To do this, in one embodiment, the junctions are offset.

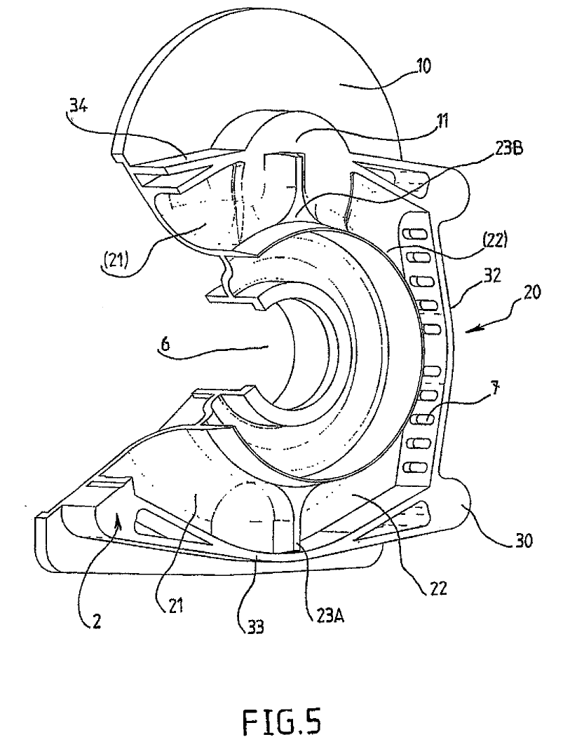

Thus FIG. 3 shows a variant embodiment of a deflector according to the invention. The deflector 20 corresponds to the deflector 1 in so far as it is integrated in an exit plate 10 of an electromagnetic retarder, that is to say formed in a single piece with it, and comprises a body 2 with an opening 6 by virtue of which the body 2 can be disposed coaxially with respect to the shaft 102 of the retarder, and with radial outlet apertures 7 visible in FIGS. 4 and 5.

On the other hand, the deflector 20 differs from the deflector 1 in that the body 2 is provided with two radial return faces 21 and 22 disposed around the opening 6 and intended to discharge the gaseous fluid radially from the retarder, for example through the radial outlet apertures 7. The two return faces 21, 22 each occupy approximately half of the return space around the opening 6, that is to say they each have the general form of an arch in a semicircle.

The dimensions of the deflector 20 are chosen, and the deflector 20 is disposed on the plate 10, so that the junctions 23a, 23b that rise up between the ends of the two return faces 21, 22 are situated in areas of the plate where there are no outlet apertures 7. This is because the junctions 23a, 23b each connect one of the partitions 33, 34 to the external sleeve 36. The junction 23a is a separation partition between the bottom parts (according to the representation in FIGS. 3 and 5) of the return faces 21 and 22 and the junction 23b is a separation partition between the top parts (still in the sense of the representation in FIGS. 3 and 5) of the return faces 21 and 22. The junction 23b is also situated in front of the protrusion 11 without this appreciably impairing the efficacy of the deflector 20. Thus blind cavities are formed, delimited by the return faces 21, 22, the external sleeve 36, the rims 31, 32, the partitions 34, 33 and the junctions 23a, 23b, as can be seen in FIGS. 3 and 5.

FIG. 4 shows, in the form of an axial section along the line IV-IV in FIG. 3, the deflector 20 of FIG. 3. This view in section shows more particularly the curved shape of the return faces 21 to 22 without which the flow of gaseous fluid would land frontally on the exit plate 10.

FIG. 5 shows the deflector 20 of FIG. 3 in a perspective view with a partial cutout for showing more particularly the curved shape of the return walls 21, 22 of the deflector 20.

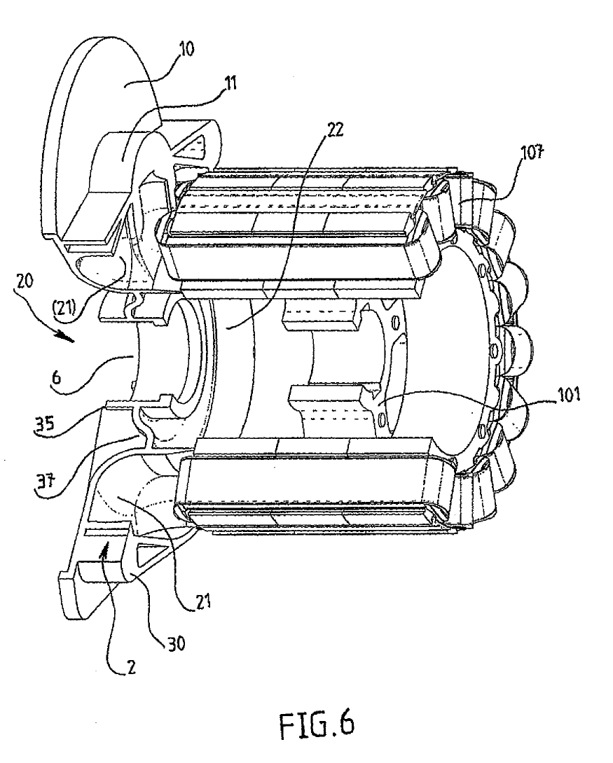

FIG. 6 shows the deflector 20 together with the induction coils 107 of the rotor 101 of the retarder. This figure shows more particularly that the return faces 21, 22 are disposed in an axial extension of the coils 107 and that the flow of cooling gaseous fluid therefore arrives, in an axial direction, on these return faces in order to be reoriented radially towards the outside of the retarder, namely mainly through the outlet apertures 7.

The arrangement of the deflector 20 with respect to the coils 107, shown in FIG. 6, applies in a similar manner also to the deflector 1 described above with reference to FIG. 2.

Naturally the present invention is not limited to the example embodiments described. Thus the generator 106 can be replaced by a brush generator scraping on collecting rings connected by cabled connections to the coils 107. And the fan 109 may be a fan with at least two stages for improving the performance of the ventilator and reducing off-load losses. Such a fan facilitates the cooling of the coils, while limiting the consumption of torque on the shaft, in particular during periods of non-use of the retarder.

To this end, such a fan comprises a hub and at least two sets of blades disposed radially around the hub. The first set of blades is disposed directly around the hub and forms a first stage of the fan, and the other set or sets of blades are disposed around the first set of blades and form successively, towards the outside of the fan, a second stage, a third stage etc of the fan, each stage having a number of blades greater than that of the lower stage. The design of the fan with at least two stages also optimises the efficiency of the fan through a variation in the inclination of the blades from the centre to the periphery.

1. Deflector for an electromagnetic retarder comprising a rotating shaft (102) with a fan (108) for making a cooling gaseous fluid flow over induction coils (107) intended to generate, on command, eddy currents in a stator (110) surrounding the rotating shaft (102) and the induction coils (107),
characterised in that the deflector (1) comprises a body (2) provided with at least one return face (3), referred to as the return face, intended to discharge the gaseous fluid radially from the retarder, the body (2) being conformed so as to make it possible to dispose the deflector (1) non-rotationally and coaxially with respect to the shaft (102) of the retarder.

2. Deflector according to claim 1, characterised in that the body (2) of the deflector is an individual piece.

3. Deflector according to claim 1, characterised in that the body (2) of the deflector is formed by a rear plate (10) of the retarder.

4. Deflector according to claim 1, characterised in that it comprises two radial return faces (3) each disposed over approximately half of the body (2) of the deflector.

5. Deflector according to claim 1, characterised in that it comprises three radial return faces (3, 4, 5), one (3) of which is disposed over approximately a first half of the body (2) of the deflector and the other two (4, 5) of which are disposed together over approximately a second half of body (2) of the deflector.

6. Deflector according to claim 4, characterised in that the radial return faces (3 to 5) each have approximately the form of a channel in an arc of a circle.

7. Deflector according to claim 4, characterised in that the radial return faces (3 to 5) each have approximately the form of a channel in a helical arch.

8. Deflector according to claim 1, characterised in that the radial return face is extended by a sleeve (36).

9. Deflector according to claim 1, characterised in that it comprises several radial return faces and in that the return faces are separated by junctions (23, 23a, 23b).

10. Deflector according to claim 1, wherein the radial return faces returns the gaseous fluid in the direction of radial apertures (7) belonging to a rim (31, 32) of the body (2).

11. Electromagnetic retarder comprising a rotating shaft (102) with a means (109) for making a cooling gaseous fluid flow over induction coils (107) intended to generate, on command, eddy currents in a stator (110) surrounding the rotating shaft (102) and the induction coils (107),
the means for making a gaseous fluid flow is a deflector (1) according to claim 1.

12. Deflector according to claim 5, characterised in that the radial return faces (3 to 5) each have approximately the form of a channel in an arc of a circle.

13. Deflector according to claim 5, characterised in that the radial return faces (3 to 5) each have approximately the form of a channel in a helical arch.
